(19) United States
(12) Patent Application Publication
(10) Pub. No.: US 2002/0016814 A1
(43) Pub. Date: Feb. 7, 2002

(54) Method, system, and program for invoking stored procedures and accessing stored procedure data

(75) Inventors: Bernhard L. Convent, Bocholt (DE); Stefan Dessloch, San Jose, CA (US); Cynthia Maro Saracco, San Jose, CA (US); Charles Daniel Wolfson, Austin, TX (US); Dirk Wollscheid, San Jose, CA (US)

Correspondence Address: David W. Victor, KONRAD RAYNES & VICTOR LLP, 315 S.Beverly Drive; Suite 210, Beverly Hills, CA, 90212, US

(73) Assignee: International Business Machines Corporation

(21) Appl. No.: 09/845,065

(22) Filed: Apr. 27, 2001

Related U.S. Application Data
(60) Provisional application No. 60/223,156, filed on Aug. 7, 2000.

(51) Int. Cl. G06F 15/16; G06F 9/46

(52) U.S. Cl. 709/203; 709/330; 707/10

(57) ABSTRACT

Provided is a method, system, and program for enabling access to data. A call is received from a client to invoke a remote interface method. A remote interface implementation accesses parameters from the received call in response to the invocation of the remote interface method. A stored procedure call is generated with the accessed parameters as input parameters of the stored procedure. The stored procedure call is transferred to a stored procedure named by the call to execute. Output from the stored procedure is received and inserted into a data object that is returned to the client.

### RELATED APPLICATIONS

This application claims the benefit of U.S. Provisional Application No. 60/223,156, filed Aug. 7, 2000, and entitled “METHODOLOGY FOR GENERATING A REMOTE INTERFACE FOR INVOKING A STORED PROCEDURE”, which provisional application is incorporated herein by reference in its entirety.

### BACKGROUND OF THE INVENTION

1. Field of the Invention

The present invention relates to a method, system, and program for invoking stored procedures and accessing stored procedure data.

2. Description of the Related Art

Many distributed applications are written using Java** programming architectures, where a client on one system requests over a network, such as the Internet, a Local Area Network (LAN), etc., data or actions with respect to a server application. For instance, the International Business Machines (“IBM”) WebSphere** Application Server implements an open distributed environment where client applications on different platforms, such as different operating systems or different programming languages etc., can interact with the server or with each other (e.g., components, such as Enterprise JavaBeans, can talk to each other on the same server or between servers). **Microsoft and Microsoft SQL Server are trademarks of Microsoft Corporation; IBM, DB2, and WEBSPHERE are trademarks of International Business Machines Corporation; ORACLE is a trademark of the Oracle Corporation; Java is a trademark of Sun Microsystems, Inc.

A common design of distributed applications uses three computing tiers: a client that interacts with the user, an application server, such as the IBM WebSphere Application Server, that contains the business logic of the application, and a resource manager that stores data. In this model, the client is isolated from having to know anything about the actual resource manager, such as the underlying database being accessed or modifications thereto. Furthermore, this approach provides additional security. Only the servers, not the clients, need direct access to the data controlled by the resource manager. The clients may comprise Java applets, Visual Basic, C++ and other client program implementation techniques commonly used in current art distributed application architectures.

For example, a client can provide a form on which a user (a person using a Web browser, for example) can enter orders for a product. The client sends this order information to the server, which checks the product database and performs tasks needed for billing and shipping. A single server is typically used by multiple clients. For example, dozens or hundreds of clients can interact with a handful of servers that control database access. The server will manage and synchronize access to the data base resource and respond to client requests with either data or status information.

One issue that e-commerce application developers encounter is that many of the robust database application programs, such as legacy database stored procedures, are written in programming languages and use data input and output parameter formats that are incompatible with commonly used client architectures, e.g., Java clients, applets, etc.

For this reason, there is a need in the art to provide an interface to allow client applications written in common programming languages, e.g., Java, C++, Visual Basic, etc., for enabling access to data collected by database stored procedures.

### SUMMARY OF THE PREFERRED EMBODIMENTS

Provided is a method, system, and program for enabling access to data. A call is received from a client to invoke a remote interface method. A remote interface implementation accesses parameters from the received call in response to the invocation of the remote interface method. A stored procedure call is generated with the accessed parameters as input parameters of the stored procedure. The stored procedure call is transferred to a stored procedure named by the call to execute. Output from the stored procedure is received and inserted into a data object that is returned to the client.

In additional implementations, the stored procedure processes a database and generates the output by performing operations on data in the database. The output is capable of comprising output that is a member of the set of output comprising one or more result sets of data from the database table and one or more output parameters resulting from stored procedure operations performed on data in the database table.

Yet further, metadata is generated describing the stored procedure output included in the data object. The metadata is added to the data object. The client may process the metadata in the received data object to determine how to access the stored procedure output from the data object.

Further provided is a method for making stored procedure programs available to application programs. A determination is made of one stored procedure program generating output needed by one application program. A remote interface implementation is generated to respond to a remote interface method that is capable of receiving a call from the application program including data and invoking a stored procedure in a database server with the data from the application program used as input. An output mapping is generated for the remote interface implementation to use to determine how to insert the stored procedure output into a data object that may be used by the application program.

The described implementations provide a technique for enabling client applications to access and invoke stored procedure programs and return data to the client applications in a format compatible with the client architecture.

### BRIEF DESCRIPTION OF THE DRAWINGS

Referring now to the drawings in which like reference numbers represent corresponding parts throughout:

FIG. 1 illustrates a computing environment in which aspects of the invention are implemented;

FIG. 2 illustrates data structures used by a remote interface implementation to manage access to a stored procedure in accordance with described implementations of the invention;

FIG. 3 illustrates logic executed in the remote interface implementation to invoke a stored procedure; and

FIG. 4 illustrates logic executed in the remote interface implementation to process the stored procedure output in accordance with described implementations of the invention.

### DETAILED DESCRIPTION OF THE PREFERRED EMBODIMENTS

In the following description, reference is made to the accompanying drawings which form a part hereof and which illustrate several embodiments of the present invention. It is understood that other embodiments may be utilized and structural and operational changes may be made without departing from the scope of the present invention.

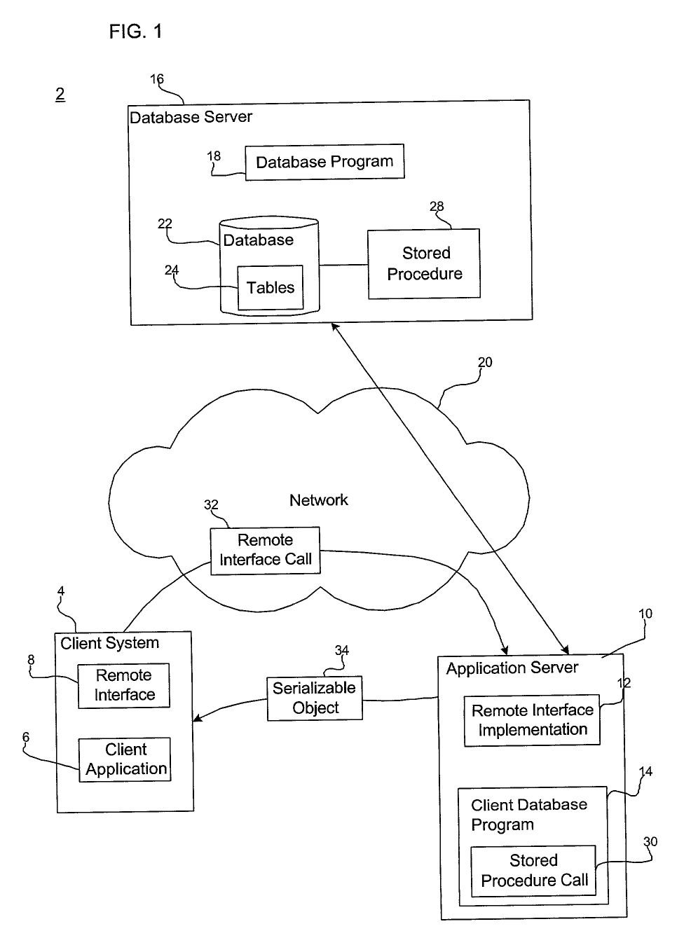

FIG. 1 illustrates a network computing environment 2 implementing aspects of the invention. The network environment 2 includes a client system 4 including a client application 6 and remote interface 8, an application server 10 including a remote interface implementation 12 and database client program 14, and a database server 16 including a database program 18, such as a database management system (DBMS) program and a database 22. The client system 4, application server 10, and database server 16 may comprise one or more servers or any other computer devices known in the art. Alternatively, the application server 10 may comprise middleware executing on the client system 4 or a different system.

The client system 4, application server 10, and database server 16 communicate over a network 20, which may comprise any network known in the art, including a Transmission Control Protocol/Internet Protocol (TCP/IP) network (e.g., an Internet, the Internet), Local Area Network, WAN, Fibre Channel, Token Ring, etc. Alternatively, the network 20 may be comprised of multiple networks. Alternatively, the database program 18, database 22, remote interface implementation 12, and client application 6 may be implemented on the same machine or any combination of separate machines, thereby avoiding the need for a network communication protocol between certain of the programs 6, 10, and 16.

The database client/server programs 14, 18 may be comprised of any database client/server program known in the art, such as IBM DB2, Oracle Corporation's ORACLE, Microsoft SQL Server, ** etc. The database programs 14 and 18 are used to access and perform operations with respect to information maintained in one or more databases 22. The database(s) 22 would consist of one or more tables 24 having rows and columns of data. Further details of the architecture and operation of a database program are described in the IBM publications “Administration Guide, Version 7 (Volumes 1, 2, and 3)”, IBM document nos. SC09-2946-00, SC09-2944-00, SC09-2945-00 (Copyright IBM. Corp., 2000) and “A Complete Guide to DB2 Universal Database,” by Don Chamberlin (Morgan/Kauftnan, 1998), which publications are incorporated herein by reference in its entirety. **Microsoft and Microsoft SQL Server are trademarks of Microsoft Corporation; IBM, DB2, and WEBSPHERE are trademarks of International Business Machines Corporation; ORACLE is a trademark of the Oracle Corporation; Java is a trademark of Sun Microsystems, Inc.

In the described implementations of FIG. 1, the database program 18 includes a stored procedure 28 that is a program invoked by a call or invocation mechanism 30 within the database client 14. The stored procedure call 30 provides input parameters to the stored procedure 28. In response to the call 30, the stored procedure 28 executes within the database server 16 and may execute Structured Query Language (SQL) statements to process database 22 records according to the input parameters or perform a non-SQL related action. The stored procedure 28 may comprise a block of procedural constructs and may include SQL statements, i.e., an application program. Additionally, the stored procedure 28 can execute program statements without querying the database tables 22. In such case, the stored procedure 28 would comprise a program that executes and generates output independently of the database 22. The stored procedure 28 can be invoked by name in the stored database call 30. Stored procedures are particularly useful for processing a large number of database records, e.g., millions to billions of records, without having to transfer data between the database server 16 and database client 14 and provide necessary input parameters. Stored procedures are maintained at the database server 16 for access and reuse by multiple database clients 14. Further details of stored procedures are described in the publication “A Complete Guide to DB2 Universal Database,” which was incorporated by reference above.

In certain implementations, the remote interface 8 and remote interface implementation 12 may be implemented using distributed computing protocols known in the art, such as the Java Remote Method Invocation (RMI), Common Object Request Broker Architecture (CORBA), Remote Procedure Call (RPC), Simple Object Access Protocol (SOAP), etc., to allow the remote interface implementation 12 and remote interface 8 to communicate. The application server 10 further runs a program to handle requests from the client, such as the IBM WebSphere application server or a Hypertext Transfer Protocol (HTTP) server. The remote interface implementation 12 may be implemented as an Enterprise JavaBean capable of handling requests from various clients, e.g., web browsers, Java applets, etc., and invoking the stored procedure 28 to gather the data requested by the client application 6. Thus, the remote interface 8 and remote interface implementation 12 comprise distributed objects that communicate over the network 20.

In implementations where the remote interface 8 and remote interface implementation 12 are implemented using Enterprise JavaBeans, the application server 10 provides security, concurrency control, transaction support, and other common business requirements. The Enterprise JavaBean remote interface implementation 12 may be accessed directly from client-side Java applications by using RMI/IIOP protocols or may be accessed indirectly from Web clients, which communicate to a HTTP server implemented in the application server 10. Additionally, the client call 32 may further invoke a Java servlet or Java Server Page (JSP) that in turn calls the remote interface implementation 12.

The remote interface implementation 12 would receive a request or call 32 from the client application 6, which may provide data related to the request. The remote interface implementation 12 would then map the data from the client call 32 to any input parameters of the stored procedure call 30. The remote interface implementation 12 would then invoke the stored procedure call 30 specifying the name of the server stored procedure 28 and any input parameters included in the client application 6. To generate the stored procedure call 30, the remote interface implementation 12 must include any required input to map any content of the client call 32 to the input parameters of the stored procedure call 30. The stored procedure 28 could return zero or more result sets of data from the tables 24 that satisfies a query. The query terms may be based on input parameters mapped from the client call 32. Additionally, the stored procedure 28 can perform calculations and operations on data in the database tables 24 or other operations that do not access the database tables 24 to generate one or more output parameters, such as an average of the values of all rows that satisfy a query condition, etc. Yet further, the stored procedure 28 can perform various actions on the database server 14 without returning any data to the node, such as sending messages. The remote interface implementation 12 must input code to map the one or more result sets and/or output parameters returned from the stored procedure 28 to a data structure that can be returned to the client application 6 via the remote interface 8.

One challenge current software architects face is that the client application 6 expects one data object to be returned in response to the call 32. However, the stored procedure output may comprise one or more result sets of multiple rows of data with different column formats and one or more output parameters. To accommodate this limitation that the client receives only a single data object in response to the call 32, the described implementations provide a technique for mapping the stored procedure output to a format compatible with the client application.

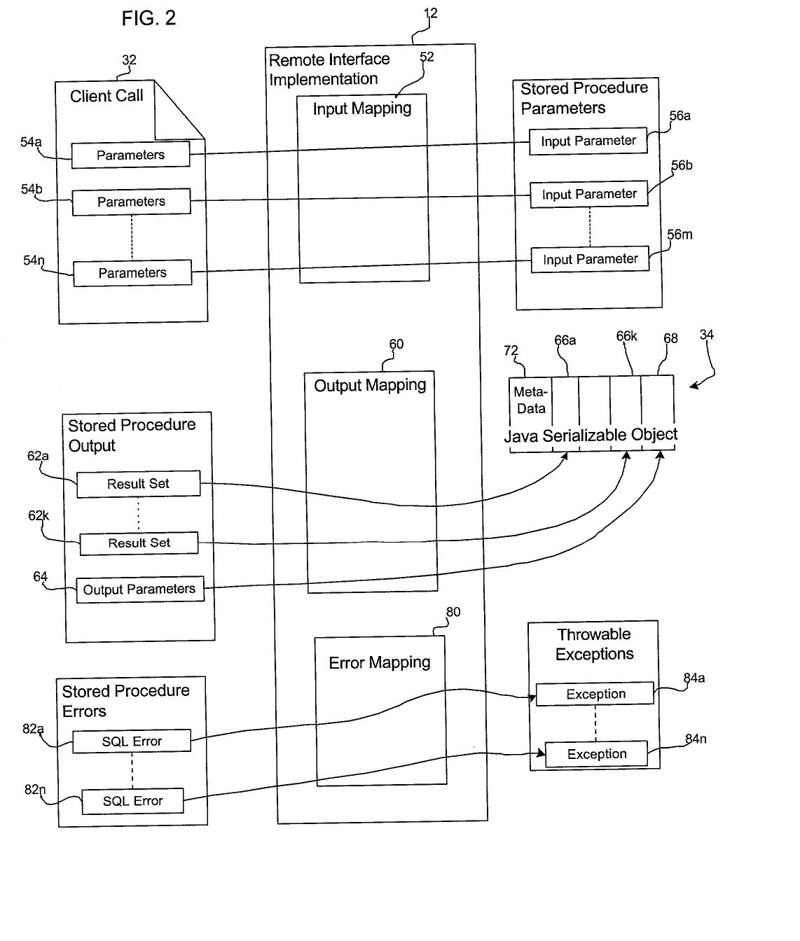

FIG. 2 illustrates data structures maintained at the remote interface implementation 12 that are used when invoking the call 30 to the stored procedure 28 and when inserting data from any returned result sets and/or parameters into a Java serializable object 34 to return to the client remote interface 8. Java Serialization is a standard Java mechanism that creates a platform independent byte stream of a Java objects state in order to allow the object to be written to a file or sent over a network. For a class to be serializable, the user has to implement the java.io.Serializable interface and the class fields have to be either of a primitive type or serializable. Alternatively, an object can be serializable if the class implements methods that write the state of non-primitive or non-serializable fields into the byte stream. FIG. 2 further illustrates the client remote interface call 32 received by the remote interface implementation 12 that includes parameters and a request for data or other information. The remote interface implementation 12 includes one or more input mappings 52 that define how one or more data parameters 54a, b . . . n of the call 32 map to the input parameters 56a, b . . . m of the stored procedure call 32 that are provided to the stored procedure 28.

The remote interface implementation 12 further includes one or more output mappings 60 that define how result sets 62a . . . k and output parameter(s) 64 returned by the stored procedure 28 map to elements 66a . . . k and 68 within the Java serializable object 34. The Java serializable object 34 includes metadata 72 that provides information on each of the elements added in the object 34. For instance, the metadata 72 may indicate which elements include output parameters, and the data types and lengths of each output parameter added to an element in the serializable object 34. The metadata 72 would further provide information on the returned result sets, including the number of different returned result sets, the structure of columns and data types in each result set, as well as the number of rows and how such result set data maps to the elements 66a . . . k in the Java serializable object 34. Thus, the result sets and/or output parameters returned by the stored procedure 28 may map to elements in the Java serializable object 34 that can be returned to the client application 6 as a single data object in response the call 32. Those skilled in the art will appreciate that a variety of serializable data object types may be used to store the stored procedure output, such as the IBM Data Access Beans callable statement object (com.ibm.db.CallableStatement).

The input 52 and output 60 mappings may comprise an index defining how the content of a client call 32 maps to input parameters 56a, b . . . m of the stored procedure call and how the returned result sets 62a . . . k and output parameters 64 from the stored procedure 28 map to elements in the Java serializable object 34.

In certain implementations, the stored procedure 28 may not return output to the remote interface implementation 12 and may instead perform other actions, such as updating the database 22, sending a message, calling other application programs, etc. In such case, the remote interface implementation 12 invoking the stored procedure 28 would not include the output mapping 60.

The application server 10 may maintain multiple remote interfaces implementations 12 invoked in response to different client calls that include different input 52 and output 60 mappings.

Additionally, the remote interface implementation 12 may maintain an error mapping 80, shown in FIG. 2, to map stored procedure errors 82a . . . n returned by the stored procedure 28, which are typically SQL errors, to Java remote exceptions 84a . . . n, such as exceptions defined using the Java.rmi.RemoteExceptions class. The client application 6 is more likely to understand and utilize the Java exceptions than the SQL error codes generated by the stored procedure. Further, this error mapping may be required to support industry standards, such as the Enterprise JavaBean specification.

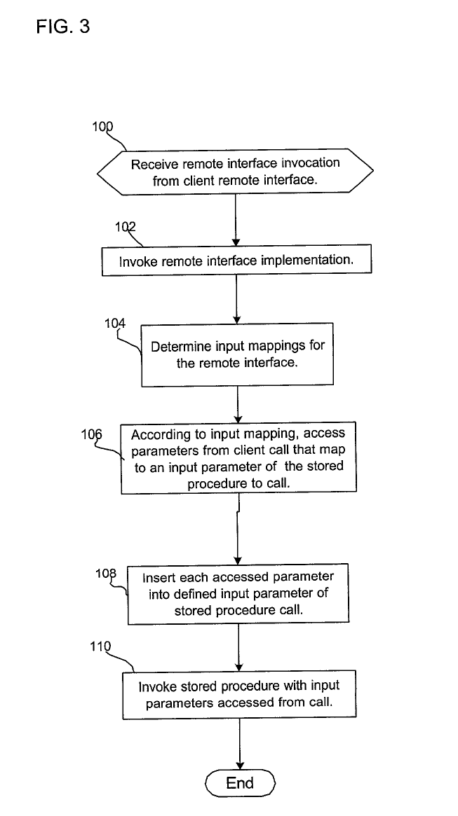

FIG. 3 illustrates logic implemented in the remote interface implementation 12 to generate the stored procedure call 30 based on parameters in the client call 32. Control begins at block 100 with the remote interface implementation 12 receiving the call 32 from the remote interface 8 to invoke the remote interface implementation 12 to access the stored procedure 28. At block 102, the remote interface implementation 12 is invoked and a determination is made (at block 104) of input mappings 52 for the remote interface implementation 12. According to the input mappings 52, the remote interface implementation 12 accesses (at block 106) parameters or data 54a, b . . . n from the client call 32 that map to one or more input parameters 56a, b . . . m of the stored procedure call 30. The accessed parameters 54a, b . . . n are then inserted (at block 108) into each input parameter 56a, b . . . m according to the accessed input mapping 52. The remote interface implementation 12 then invokes (at block 110) the stored procedure call 30 with the input parameters from the client call 32.

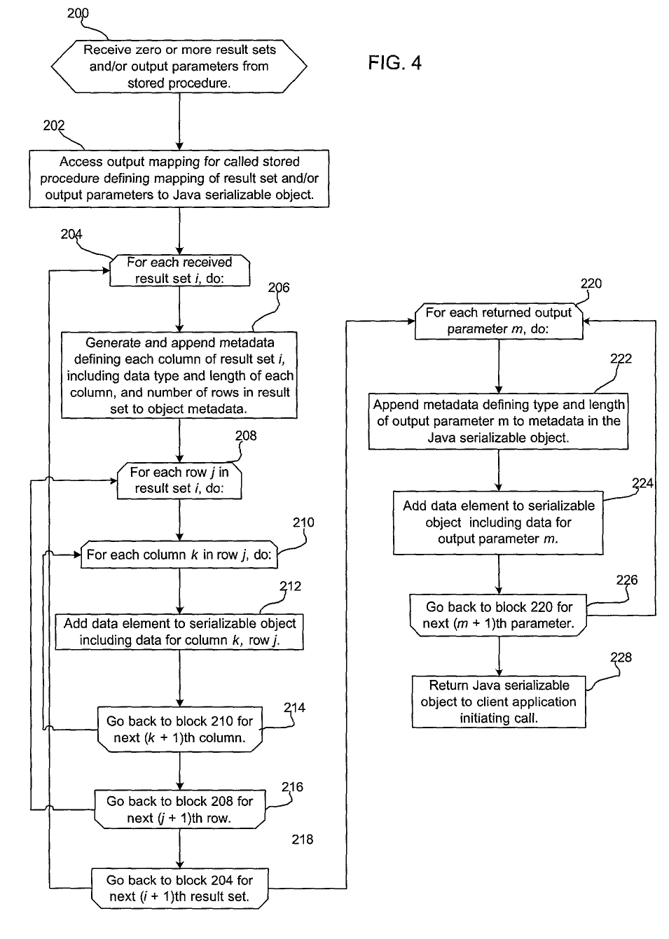

FIG. 4 illustrates the logic implemented in the remote interface implementation 12 to process output generated by the stored procedure 28 in response to the call 30. Upon receiving (at block 200) zero or more result sets of rows and/or output parameters generated by the stored procedure 28, the remote interface implementation 12 accesses (at block 202) the output mapping 60 for the remote interface implementation 12, which defines a mapping of result set data and/or output parameters to the Java serializable object 34 to return to the client remote interface 8, which in turn returns the object to the client application 6. The output parameters may be fixed predefined numbers and fields, such as a calculated values, whereas the number of result sets returned may vary. At blocks 204 to 218, the remote interface implementation 12 performs steps 206 through 218 for each received result set i. For each received result set i, the remote interface implementation 12 generates (at block 206) metadata 72 defining each column of result set i, including the data type and length of each column, and the number of rows in the result set i. For each row j in result set i (at blocks 208 to 216) and for each column k in row j (at block 210 to 214), the remote interface implementation 12 adds a data element 66a . . . k to the Java serializable object 34, and inserts in this added element the data for column k, row j in result set i. This operation is performed for all columns in all rows in result set i, until the Java serializable object 34 is populated with the data for the entire result set i. This operation is then performed for any further result sets i (at block 218) in the output received from the stored procedure 28.

At blocks 220 to block 226, for each returned output parameter m, the metadata is generated and appended to the metadata 72 (at block 222) defining the type and length of the output parameter m. A data element 68 is then added to the Java serializable object 34 into which the data for output parameter m is inserted. After the Java serializable object 34 is generated to include the data and metadata describing the result set and/or output parameter data from the stored procedure 28, the Java serializable object 34 is returned (at block 228) to the client application 6 via the remote interface 8 as a single data object.

The client application 6 may be coded as a generic client for processing Java serializable objects, CallableStatements, etc, without assuming any prior knowledge about the CallableStatement's internal structure. Instead, the client application 6 may rely on the metadata 72 contained within the returned object 34 to parse the object and work with the relevant components, such as the output parameters and result sets returned by the procedure.

With the logic of FIGS. 3 and 4, the remote interface implementation 12 is capable of using stored procedure 28 programs on behalf of client applications 6 and returning a single data object to the client application 6 that would include all the output of the stored procedure 28, which may comprise multiple data points, as well as self-describing metadata 72. The client application 4 would be coded to process the metadata 72 to determine the structure and format of the output results in the Java serializable object 34 in order to access and utilize the data therein. With the described implementations, the remote interface implementation 12 enables a client application to access data gathered by a stored procedure program 28, which may be a legacy program, even though the stored procedure program 28 produces output that would otherwise be in an inaccessible format to the application. For instance, by using industry standard distributed computing architecture, such as the Enterprise JavaBean architecture, the functionality and output of the stored procedures are made available to Enterprise JavaBean client components without having to rewrite the stored procedure code.

Following is an example of the application of the described implementations. In this example, the client application 6 is associated with a financial-oriented Web site that enables users to register with the site, track their investment portfolios, and post comments to electronic bulletin boards. The database that supports this Web site includes tables with CLIENT information, PORTFOLIO information for each client, and an index of postings made to bulletin BOARDS. The database 22 also contains a stored procedure 28 CLENTREPORT that provides a comprehensive profile of registered site users, including their investments and postings they have made to electronic bulletin boards. Client names and e-mail addresses are included with this report to allow the marketing staff to contact the user with suggestions regarding additional products or services being offered.

The stored procedure 28 of interest in this example may process three separate SQL statements individually, collecting appropriate data in output parameters and in result sets that will be returned to the client application. In this case, the output parameters include the name and email address of the Web site client and the result sets include information about the portfolio holdings and bulletin board postings for a particular user. For instance, a user at a web browser (not shown) could submit an HTTP request including a user ID and request for portfolio information for the user. The HTTP request would be provided to the client application 6, which in turn would call the remote interface. The remote interface would then provide the user ID and request for portfolio information to the remote interface implementation 12, which in turn would generate the stored procedure call 30 input to cause the stored procedure 28 to obtain portfolio information for the user identified with the provided user ID. The stored procedure 28 output from all three tables may then be encapsulated into a Java serializable object 34, such as a “com.ibm.db.CallableStatement”, or other data object, to return to the client application 6. The client application 6 would then unpack and analyze the information and insert into a page capable of being rendered in the web browser of the user that initiated the HTTP request for the portfolio information.

The stored procedure could be used for numerous other e-commerce uses, such as to query the database and gather records from which shipping costs can be calculated, inventory reviewed, shipments processed, trend analysis returned, etc. In this way, the processing burdens are transferred from the client or application server to the database server.

With the described implementations, development and maintenance costs for e-business and other applications are reduced because such applications may utilize preexisting legacy stored procedures without having to rewrite the stored procedure code. Application developers not accustomed to SQL and the database environment may have difficulty developing applications that implement the operations performed by the legacy stored procedure. With the described implementations, the application developer does not need extensive knowledge of SQL and the structure and arrangement of the database. Instead, the application developer need only create remote interfaces that make the stored procedure output available to the client programs.

### ADDITIONAL IMPLEMENTATION DETAILS

the preferred embodiments may be implemented as a method, apparatus or article of manufacture using standard programming and/or engineering techniques to produce software or code. The term “article of manufacture” as used herein refers to code or logic implemented in a computer readable medium (e.g., magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which preferred embodiments are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Of course, those skilled in the art will recognize that many modifications may be made to this configuration without departing from the scope of the present invention, and that the article of manufacture may comprise any information bearing medium known in the art.

In certain implementations, the stored procedure 28 output was placed in a Java serializable object. However, alternative data object types may be used to store the aggregated output data.

In the described implementations, the remote interface was implemented as an Enterprise JavaBean. However, those skilled in the art will appreciate that any component architecture may be used to implement the remote interface 8, remote interface implementation 12, client application 6, and remote interface call 32, and that the invention is not limited to Java implementations.

In one Java implementation, the remote interface may be written as a stateless session Enterprise JavaBean in order to minimize the number of mandatory methods that must be coded, minimize resource consumption and allow for use with multiple clients.

In the above described implementations, the remote interface implementation 12 invoked by the client remote interface call 32 accessed parameters from the client call and invoked the stored procedure call. Alternatively, the remote interface implementation 12 may call another program component to call the stored procedure call.

In further implementations, the application server 10 may maintain multiple remote interface implementations 12 implemented as multiple Enterprise JavaBeans.

In the described implementations, the client call 32 directly invoked the remote interface implementation 12. Additionally, the client application 6 may comprise a web or Hypertext Markup Language (HTML) client that transmits the call 32 as a Hypertext Transfer Protocol (HTTP) request that invokes the remote interface implementation 12 indirectly through a Java servlet.

Preferred embodiments were described with respect to specific data structures, such as input and output mappings, for generating and transferring calls to a stored procedure program. However, those skilled in the art will recognize that modifications may be made to the manner in which client applications map to input parameters of the stored procedure and how the stored procedure output is encapsulated in a single data object.

In the described implementations, the stored procedure produced output that was transmitted to the client application. In additional implementations, the stored procedure may not generate output data to return to the client application 6, but may instead transmit output to other applications or perform some other actions, such as updating the database, sending an e-mail, etc.

In the above described implementations, the remote interface implementation 12 invoked a stored procedure that returned return result sets. In additional implementations, the stored procedure may not generate result sets to return to the client application 6, but may instead transmit result sets or other output to additional applications or perform some other actions, such as updating the database, sending an e-mail, etc.

The application server 10, or middleware, including the remote interface implementation 12 and client database program 14 may be implemented in the client system 4 or another computing device in the network 20.

The foregoing description of the preferred embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for enabling access to data, comprising:
receiving a call from a client to invoke a remote interface method;
accessing, with a remote interface implementation, parameters from the received call in response to the invocation of the remote interface method;
generating a stored procedure call with the accessed parameters as input parameters of the stored procedure;
transferring the stored procedure call to a stored procedure named by the call to execute;
receiving output from the stored procedure;
inserting the received output from the stored procedure into a data object; and
returning the data object to the client.

2. The method of claim 1, wherein the stored procedure executes in a database server and generates the output, wherein the output is capable of comprising output that is a member of the set of output comprising one or more result sets of data from the database table and one or more output parameters resulting from stored procedure operations performed on data in the database table.

3. The method of claim 1, further comprising processing, with the remote interface implementation, an input mapping to determine the parameters in the client call to use as input parameters to the stored procedure call.

4. The method of claim 1, further comprising:
receiving the stored procedure output after the stored procedure program completes execution.

5. The method of claim 1, further comprising processing an output mapping indicating how the stored procedure output is mapped to the data object.

6. The method of claim 5, wherein the output is capable of including result sets and parameters, wherein the output mapping indicates an order in which the received result sets and parameters are added to the data object.

7. The method of claim 1, further comprising:
generating metadata describing the stored procedure output included in the data object; and
adding the metadata to the data object.

8. The method of claim 7, further comprising:
processing, with the client, the metadata in the received data object to determine how to access the stored procedure output from the data object.

9. The method of claim 7, wherein the data object is comprised of multiple elements, wherein the stored procedure output includes rows of data from at least one result set, wherein inserting the stored procedure output into the data object further comprises inserting data from each column in each row in each result set to one element in the data object, and wherein the metadata defines structure and types of data in each element.

10. The method of claim 7, wherein the data object is comprised of multiple elements, and wherein the stored procedure output is capable of including multiple output parameters, wherein inserting the stored procedure output into the data object further comprises inserting each output parameter into one element in the data object, and wherein the metadata provides information on structure and type of the data in each element.

11. The method of claim 1, wherein the client only receives one data object with stored procedure output in response to the call.

12. The method of claim 1, wherein the remote interface implementation is implemented as a Enterprise JavaBean and wherein the data object comprises a Java serializable object.

13. A method for making stored procedure programs available to application programs, comprising:
determining one stored procedure program generating output needed by one application program;
generating a remote interface implementation to respond to a remote interface method capable of receiving a call from the application program including data and invoking a stored procedure in a database server with the data from the application program used as input; and
generating an output mapping for the remote interface implementation to use to determine how to insert the stored procedure output into a data object that may be used by the application program.

14. The method of claim 13, wherein the generated remote interface implementation inserts metadata into the data object providing information on the stored procedure output inserted into the data object.

15. A system for enabling access to data, comprising:
means for receiving a call from a client to invoke a remote interface method;
means for accessing, with a remote interface implementation, parameters from the received call in response to the invocation of the remote interface method;
means for generating a stored procedure call with the accessed parameters as input parameters of the stored procedure;
means for transferring the stored procedure call to a stored procedure named by the call to execute;
means for receiving output from the stored procedure;
means for inserting the received output from the stored procedure into a data object; and
means for returning the data object to the client.

16. The system of claim 15, wherein the stored procedure executes in a database server and generates the output, wherein the output is capable of comprising output that is a member of the set of output comprising one or more result sets of data from the database table and one or more output parameters resulting from stored procedure operations performed on data in the database table.

17. The system of claim 15, further comprising means for processing, with the remote interface implementation, an input mapping to determine the parameters in the client call to use as input parameters to the stored procedure call.

18. The system of claim 15, further comprising:
means for receiving the stored procedure output after the stored procedure program completes execution.

19. The system of claim 15, further comprising means for processing an output mapping indicating how the stored procedure output is mapped to the data object.

20. The system of claim 19, wherein the output is capable of including result sets and parameters, wherein the output mapping indicates an order in which the received result sets and parameters are added to the data object.

21. The system of claim 15, further comprising:
means for generating metadata describing the stored procedure output included in the data object; and
means for adding the metadata to the data object.

22. The system of claim 21, further comprising:
means for processing, with the client, the metadata in the received data object to determine how to access the stored procedure output from the data object.

23. The system of claim 21, wherein the data object is comprised of multiple elements, wherein the stored procedure output includes rows of data from at least one result set, wherein the means for inserting the stored procedure output into the data object further inserts data from each column in each row in each result set to one element in the data object, and wherein the metadata defines structure and types of data in each element.

24. The system of claim 21, wherein the data object is comprised of multiple elements, and wherein the stored procedure output is capable of including multiple output parameters, wherein the means for inserting the stored procedure output into the data object further inserts each output parameter into one element in the data object, and wherein the metadata provides information on structure and type of the data in each element.

25. The system of claim 15, wherein the client only receives one data object with stored procedure output in response to the call.

26. The system of claim 15, wherein the remote interface implementation is implemented as a Enterprise JavaBean and wherein the data object comprises a Java serializable object.

27. A system for making stored procedure programs available to application programs, comprising:
means for determining one stored procedure program generating output needed by one application program;
means for generating a remote interface implementation to respond to a remote interface method capable of receiving a call from the application program including data and invoking a stored procedure in a database server with the data from the application program used as input; and
means for generating an output mapping for the remote interface implementation to use to determine how to insert the stored procedure output into a data object that may be used by the application program.

28. The system of claim 27, wherein the generated remote interface implementation inserts metadata into the data object providing information on the stored procedure output inserted into the data object.

29. An article of manufacture for enabling access to data by:
receiving a call from a client to invoke a remote interface method;
accessing, with a remote interface implementation, parameters from the received call in response to the invocation of the remote interface method;
generating a stored procedure call with the accessed parameters as input parameters of the stored procedure;
transferring the stored procedure call to a stored procedure named by the call to execute;
receiving output from the stored procedure;
inserting the received output from the stored procedure into a data object; and
returning the data object to the client.

30. The article of manufacture of claim 29, wherein the stored procedure executes in a database server and generates the output, wherein the output is capable of comprising output that is a member of the set of output comprising one or more result sets of data from the database table and one or more output parameters resulting from stored procedure operations performed on data in the database table.

31. The article of manufacture of claim 29, further comprising processing, with the remote interface implementation, an input mapping to determine the parameters in the client call to use as input parameters to the stored procedure call.

32. The article of manufacture of claim 29, further comprising:
receiving the stored procedure output after the stored procedure program completes execution.

33. The article of manufacture of claim 29, further comprising processing an output mapping indicating how the stored procedure output is mapped to the data object.

34. The article of manufacture of claim 33, wherein the output is capable of including result sets and parameters, wherein the output mapping indicates an order in which the received result sets and parameters are added to the data object.

35. The article of manufacture of claim 29, further comprising:
generating metadata describing the stored procedure output included in the data object; and
adding the metadata to the data object.

36. The article of manufacture of claim 35, further comprising:
processing, with the client, the metadata in the received data object to determine how to access the stored procedure output from the data object.

37. The article of manufacture of claim 35, wherein the data object is comprised of multiple elements, wherein the stored procedure output includes rows of data from at least one result set, wherein inserting the stored procedure output into the data object further comprises inserting data from each column in each row in each result set to one element in the data object, and wherein the metadata defines structure and types of data in each element.

38. The article of manufacture of claim 35, wherein the data object is comprised of multiple elements, and wherein the stored procedure output is capable of including multiple output parameters, wherein inserting the stored procedure output into the data object further comprises inserting each output parameter into one element in the data object, and wherein the metadata provides information on structure and type of the data in each element.

39. The article of manufacture of claim 29, wherein the client only receives one data object with stored procedure output in response to the call.

40. The article of manufacture of claim 29, wherein the remote interface implementation is implemented as a Enterprise JavaBean and wherein the data object comprises a Java serializable object.

41. An article of manufacture for making stored procedure programs available to application programs by:
determining one stored procedure program generating output needed by one application program;
generating a remote interface implementation to respond to a remote interface method capable of receiving a call from the application program including data and invoking a stored procedure in a database server with the data from the application program used as input; and
generating an output mapping for the remote interface implementation to use to determine how to insert the stored procedure output into a data object that may be used by the application program.

42. The article of manufacture of claim 41, wherein the generated remote interface implementation inserts metadata into the data object providing information on the stored procedure output inserted into the data object.
